(19) United States
(12) Patent Application Publication
(10) Pub. No.: US 2019/0055763 A1
(43) Pub. Date: Feb. 21, 2019

(54) ADJUSTABLE GATE HINGE SYSTEM

(71) Applicant: Michael McGraw, Allen, TX (US)

(72) Inventor: Michael McGraw, Allen, TX (US)

(21) Appl. No.: 15/948,788

(22) Filed: Apr. 9, 2018

Related U.S. Application Data
(60) Provisional application No. 62/487,565, filed on Apr. 20, 2017.

(51) Int. Cl. E05D 5/04; E05D 3/02; E06B 11/04

(52) U.S. Cl. CPC E05D 5/04; E05D 3/02; E05Y 2800/296; E05Y 2900/402; E06B 11/04

(57) ABSTRACT

A horizontal adjustable hinge system that is capable of replacing existing hinges. The adjustable hinge assembly comprises of a first and second horizontally mounted support legs which comprise of two elongated slots for fasteners. These elongated slots for fasteners allow for adjustment of the distance between the fixed support structure and the movable structure. There is also two square holes for additional fortifying of the hinge assemble to the structure. The system also has a vertical mounted pole bracket capable of acting as a clamp over a standard post pole and having a multiplicity of openings for the insertion of fasteners.

### BACKGROUND

### 1. Field of the Invention

The present invention relates generally to gate mounting hinge systems, and more specifically, to an adjustable gate mounting hinge system that is adjustable while supporting the gate.

### 2. Description of Related Art

Gate mounting hinge systems are well known in the art and are effective means of securing and supporting a gate to a fixed post or other stationary structure. For example, FIG. 1 depicts a conventional gate mounting hinge system 101 having a moveable leg 103 and a non-moveable leg 105. The moveable leg 103 has bolt holes 107 for mounting bolts used to secure the moveable leg 103 to the gate. The non-moveable leg 105 has bolt holes 109 for mounting bolts used to secure the non-moveable leg 107 to the fix post or other stationary structure. The moveable leg 103 and non-moveable leg 107 have a barrel for a pivoting pin 111 which align allowing the two legs 103, 107 to work as one unit letting the gate swing open when the user engages the gate.

One of the problems commonly associated with hinge system 101 is that over time it starts to sag due to the loosening of the mounting bolts in the wood and the weight of the gate on the hinges. Tightening the mounting bolts is only a temporary solution as the wear on the wood fibers after time will make it impossible to hold the bolt. Sagging gates can damage the gate itself, the surface below the gate, and the fixed post or other stationary structure to which the gate is attached to.

Replacement of hinge system 101 with another hinge system 101 is a time-consuming task as the user generally must remove the gate and the initial hinge system 101 and realign the gate before reinstalling new hinge system 101.

Accordingly, although great strides have been made in the area of gate mounting hinges, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a front view of a common gate mounting hinge system;

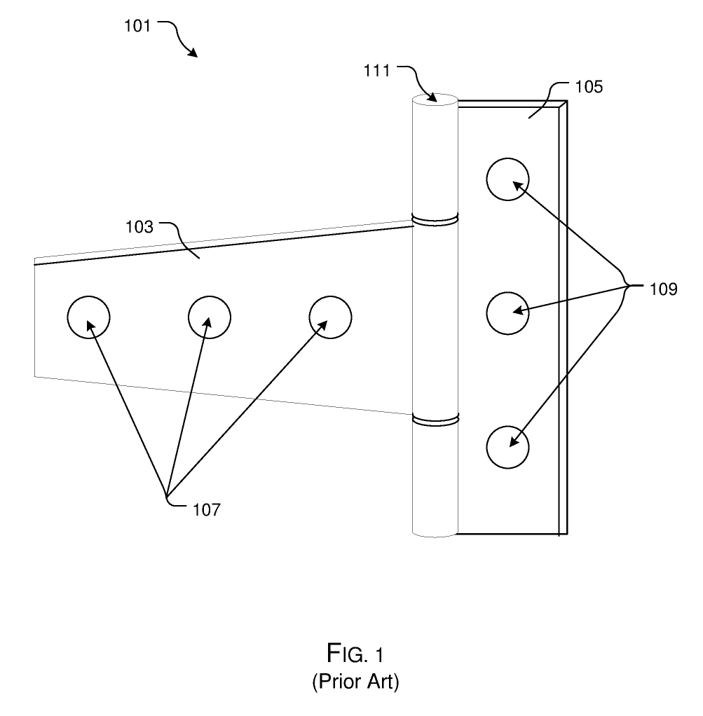

FIG. 2 is an orthogonal front view of an adjustable gate mounting hinge system in accordance with a preferred embodiment of the present application;

FIG. 3 is a perspective view of the adjustable gate mounting hinge system in accordance with a preferred embodiment of the present application;

FIG. 4 is an orthogonal view of an adjustable gate mounting hinge showing the use of two adjustable gate mounting hinges; and

FIG. 5 is an orthogonal front view of a pole mounting bracket in accordance with a preferred embodiment of the present application.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional gate mounting hinge systems. Specifically, the replacement of existing gate mounting hinges and correct the sagging of the existing gate without having to remove the gate. In the preferred embodiment, the replacement of the existing gate mounting hinges and bolts are through the horizontal leg members of the adjustable gate mounting hinge system and/or the existing vertical pole mounting brackets. The adjust gate mounting hinge adjusts horizontal to allow the gate to be mounted the same distance from the vertical pole as it was originally mounted or the gate mounting hinge system can be used when mounting a new gate. It should be noted that the bolts or fasteners used to secure the hinges go completely through the gate structure and the fixed post or other stationary structure to which the gate is attached. On the other side of the structures there is a horizontal support member, typically a 2x4 or a metal bracket or other material bracket depending on the embodiment. This horizontal support member prevents the gate from sagging due to the load of the gate being shared between the hinge and the horizontal support member. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

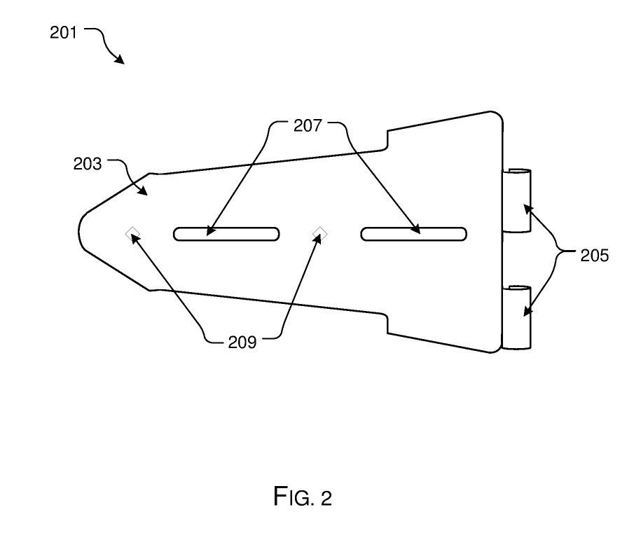

Referring now to the drawings wherein like reference characters identify corresponding or similar elements throughout the several views, FIG. 2 depicts an orthogonal front view of an adjustable gate mounting hinge system in accordance with a preferred embodiment of the present application. It will be appreciated that system 201 overcomes one or more of the above-listed problems commonly associated with conventional gate mounting hinge systems.

In the contemplated embodiment, system 201 includes a horizontal leg 203, pivoting housing 205 for pivoting post, bolt slots 207, and screw holes 209.

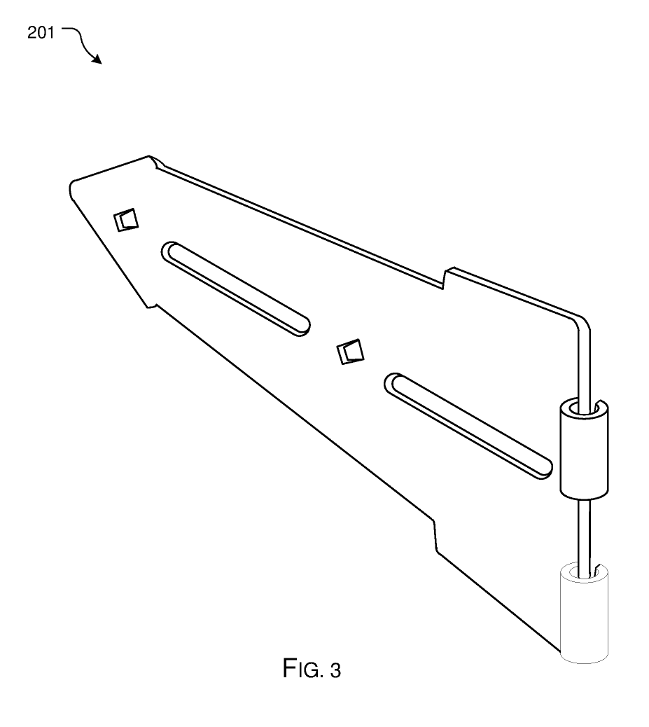

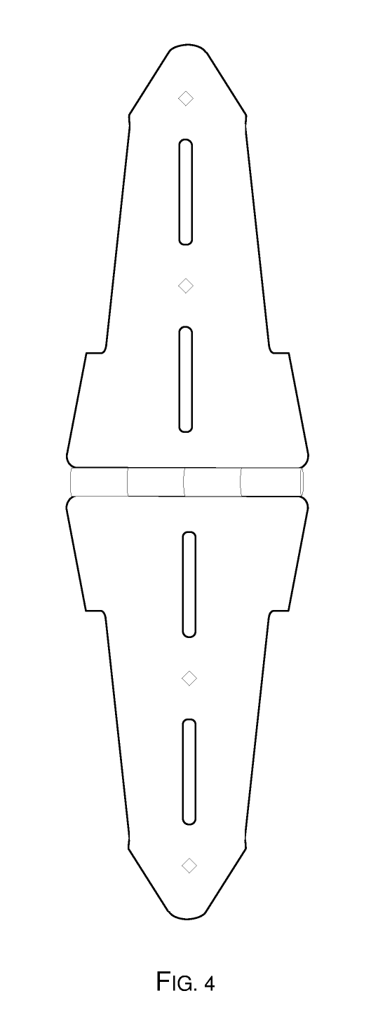

FIG. 3 depicts a perspective view of the adjustable gate mounting hinge system in accordance with a preferred embodiment of the present application and FIG. 4 depicts an orthogonal view of an adjustable gate mounting hinge showing the use of two adjustable gate mounting hinges. This is the configuration in the preferred embodiment where one horizontal leg 203 would be attached to the gate structure and the other horizontal leg would be attached to a fixed post or other stationary structure.

The pivoting housing 205 is mounted on the horizontal leg on the edge that abuts another horizontal leg 203 as shown in FIG. 4. The pivoting housing 205 is a tube-like structure that is not complete sealed having a gap on one side of the tube. The pivoting housing 205 accommodates the pivoting post and when the gate is engaged by the user pivots around the pivoting post allowing the gate to open.

The bolts slots 207 which accommodates carriage bolts or other appropriate fasteners in the preferred embodiment allows the bracket to be adjusted to the correct horizontal position. The fastener extends through the length of the gate structure and a horizontal support member or a bracket depending on the embodiment or use. The fastener is secured after the gate is in the correct horizontal position preventing the fastener from being pulled out from the gate structure. Once the gate is in the correct horizontal position the screw holes 209 are then engaged with a wood screw or other appropriate screw to secure system 201 in the desired horizontal position. Securing the gate structure and the fixed post or other stationary structure to which the gate is attached to with the legs 203 by using the bolt slots 207 and the screws holes 209 the stress on the fasteners are the wood around the fasteners are reduced.

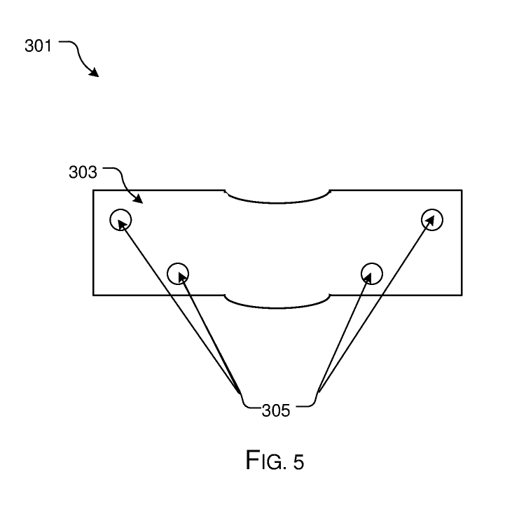

Now referring to FIG. 5, an orthogonal front view of a pole mounting bracket 301 in accordance with a preferred embodiment of the present application. The bracket 301 comprises of a clamp 303 and bolt holes 305. The bolt holes 305 are aligned to the bolt slots 207 in the adjustable hinge horizontal leg 203 that is on the other side of the fixed post or other stationary structure. It should be appreciated that the bracket 301 can have a multiplicity of bolt holes 305. It should also be appreciated that other brackets can be used with the system 201.

It should be appreciated that one of the unique features believed characteristic of the present application is the ability to replace the old gate hinges without having to remove the gate and the ability to mount the gate the same distance by adjusting the hinge along the bolt slots 207 from the fixed post or other stationary structure that it originally was mounted.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. An adjustable hinge assembly system comprising:
a first horizontally mounted support leg;
a second horizontally mounted support leg; and
a vertically mounted bracket.

2. The hinge assembly in claim 1, in which the first and second horizontally mounted support legs comprises of:
two or four elongated slots for fasteners allowing for adjustment of the distance between the fixed support structure and the movable structure; and
two square holes for additional fortifying of hinge assembly to the structure.

3. The hinge assembly in claim 1, in which the vertically mounted pole bracket comprises of:
a bracket capable of acting as a clamp over a standard post pole; and
a multiplicity of openings for the insertion of fasteners.
